(19) United States
(12) Patent Application Publication
(10) Pub. No.: US 2025/0150877 A1
(43) Pub. Date: May 8, 2025

(54) WIRELESS COMMUNICATION METHOD, USER EQUIPMENT, NETWORK EQUIPMENT, AND STORAGE MEDIUM

(71) Applicant: SAMSUNG ELECTRONICS CO., LTD., Suwon-si, Gyeonggi-do (KR)

(72) Inventors: Zhe CHEN, Beijing (CN); Feifei SUN, Beijing (CN); He WANG, Beijing (CN)

(21) Appl. No.: 18/838,385

(22) PCT Filed: Apr. 19, 2023
(86) PCT No.: PCT/KR2023/005294

§ 371 Date: Aug. 14, 2024

(30) Foreign Application Priority Data
Apr. 22, 2022 (CN) 202210431267.0
Sep. 28, 2022 (CN) 202211191816.8
Oct. 9, 2022 (CN) 202211229267.9

(51) Int. Cl. H04W 24/10; H04L 27/26; H04W 64/00

(52) U.S. Cl. CPC H04W 24/10; H04L 27/261; H04W 64/003

(57) ABSTRACT

The disclosure relates to a 5G or 6G communication system for supporting a higher data transmission rate. The disclosure relates to a wireless communication method, a user equipment, a network equipment and a storage medium. The wireless communication method includes: a user equipment transmits reported information to a network equipment, wherein the reported information includes: identification information of reference signal resources; and/or reported values corresponding to the reference signal resources.

### TECHNICAL FIELD

The disclosure relates to a communication field, in particular to a wireless communication method, a user equipment, a network equipment and a storage medium.

### BACKGROUND ART

In order to meet the increasing demand for wireless data communication services since the deployment of 4G communication systems, efforts have been made to develop improved 5G or quasi-5G communication systems. Therefore, 5G or quasi-5G communication systems are also called “super-4G networks” or “post-LTE systems”.

In order to achieve a higher data rate, 5G communication systems are implemented in higher frequency (millimeter, mmWave) bands, e.g., 30 Hz or 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure provides a wireless communication method, a user equipment, a network equipment, an electronic equipment, and a storage medium, to at least solve problems in related technologies.

### Solution to Problem

According to an aspect of an embodiment of the disclosure, there is provided a wireless communication method, including: a user equipment transmits reported information to a network equipment, wherein the reported information includes: identification information of reference signal resources; and/or reported values corresponding to the reference signal resources.

According to an embodiment of the disclosure, the reported information further includes at least one of: spatial information of the reference signal resources, port information of the reference signal resources, grouping information of the reference signal resources, quantization approach information corresponding to the reported values.

According to an embodiment of the disclosure, the spatial information includes spatial relationship information of the reference signal resources.

According to an embodiment of the disclosure, the quantization approach corresponding to the reported values is one of a first quantization approach and a second quantization approach.

According to an embodiment of the disclosure, a quantization step size of the first quantization approach is less than or equal to a quantization step size of the second quantization approach; and/or a range of the first quantization approach is less than or equal to a range of the second quantization approach.

According to an embodiment of the disclosure, the wireless communication method further includes: the user equipment determines the quantization approach corresponding to the reported values according to indication information of the network equipment about the quantization approach corresponding to the reported values; or the user equipment selects the quantization approach corresponding to the reported values among the first quantization approach and the second quantization approach according to a first condition, and transmits indication information about the selected quantization approach to the network equipment.

According to an embodiment of the disclosure, the reference signal resources have a spatial relationship.

According to an embodiment of the disclosure, the spatial relationship includes at least one of: spatial filters corresponding to the reference signal resources are the same; angles of the spatial filters corresponding to the reference signal resources satisfy a second condition; the reference signal resources cannot be received simultaneously.

According to an embodiment of the disclosure, the wireless communication method further includes: the user equipment determines whether the reference signal resources have the spatial relationship according to indication information about the spatial relationship of the network equipment; or the user equipment determines whether the reference signal resources have the spatial relationship according to a first condition, and transmits indication information about whether the reference signal resources have the spatial relationship to the network equipment.

According to an embodiment of the disclosure, the first condition is related to measurement values corresponding to the reference signal resources and/or a scene where the user equipment is located.

According to an embodiment of the disclosure, the reference signal resources corresponds to a plurality of groups, wherein the reference signal resources within a same group have a spatial relationship and/or quantization of measurement values corresponding to the reference signal resources is performed for each group respectively.

According to an embodiment of the disclosure, the reported information is carried by one of: a physical layer signaling; a media access control layer signaling; a higher level signaling.

According to an aspect of an embodiment of the disclosure, there is provided a wireless communication method, including: a network equipment receives reported information from a user equipment, wherein the reported information includes: identification information of reference signal resources; and/or reported values corresponding to the reference signal resources.

According to an embodiment of the disclosure, the reported information further includes at least one of: spatial information of the reference signal resources, port information of the reference signal resources, grouping information of the reference signal resources, quantization approach information corresponding to the reported values.

According to an embodiment of the disclosure, the spatial information includes spatial relationship information of the reference signal resources.

According to an embodiment of the disclosure, the quantization approach corresponding to the reported values is one of a first quantization approach and a second quantization approach.

According to an embodiment of the disclosure, a quantization step size of the first quantization approach is less than or equal to a quantization step size of the second quantization approach; and/or a range of the first quantization approach is less than or equal to a range of the second quantization approach.

According to an embodiment of the disclosure, the wireless communication method further includes: the network equipment transmits indication information about the quantization approach corresponding to the reported values to the user equipment.

According to an embodiment of the disclosure, the reference signal resources have a spatial relationship.

According to an embodiment of the disclosure, the spatial relationship includes at least one of: spatial filters corresponding to the reference signal resources are the same; angles of the spatial filters corresponding to the reference signal resources satisfy a second condition; the reference signal resources cannot be received simultaneously.

According to an embodiment of the disclosure, the wireless communication method further includes: the network equipment transmits indication information about the spatial relationship to the user equipment.

According to an embodiment of the disclosure, the reference signal resources corresponds to a plurality of groups, wherein the reference signal resources within a same group have a spatial relationship and/or quantization of measurement values corresponding to the reference signal resources is performed for each group respectively.

According to an embodiment of the disclosure, the reported information is carried by one of: a physical layer signaling; a media access control layer signaling; a higher level signaling.

According to an aspect of an embodiment of the disclosure, there is provided a user equipment, including: a transceiver; at least one processor, coupled to the transceiver and configured to perform the above wireless communication methods.

According to an aspect of an embodiment of the disclosure, there is provided a network equipment, including: a transceiver; at least one processor, coupled to the transceiver and configured to perform the above wireless communication methods.

According to an aspect of an embodiment of the disclosure, there is provided a computer-readable storage medium storing indications, characterized in that the indications, when performed by the at least one processor, cause the at least one processor to perform the above wireless communication methods.

The wireless communication method according to an embodiment of the disclosure may contribute to reduce the receiving performance degradation of the receiving side (terminal side) and improve the system performance. It should be understood that the above general description and the following detailed description are only exemplary and explanatory, and may not limit the disclosure.

### Advantageous Effects of Invention

The disclosure may provide a wireless communication method, a user equipment, a network equipment, an electronic equipment, and a storage medium, to at least solve problems in related technologies.

### BRIEF DESCRIPTION OF DRAWINGS

The drawings herein are incorporated into the specification and constitute a part of the specification, show example embodiments conforming to the disclosure, and together with the specification to explain the principle of the disclosure, and do not constitute an improper restriction of the disclosure.

FIG. 1 illustrates an example wireless network 100 according to an embodiment of the disclosure.

FIG. 2a illustrates an example wireless transmission path according to an embodiment of the disclosure.

FIG. 2b illustrates an example wireless reception path according to an embodiment of the disclosure.

FIG. 3a illustrates an example UE 116 according to an embodiment of the disclosure.

FIG. 3b illustrates an example gNB 102 according to an embodiment of the disclosure.

FIG. 4 is a flow chart of a wireless communication method performed by a user equipment according to an embodiment of the disclosure.

FIG. 5 is a flow chart of a wireless communication method performed by a network equipment according to an embodiment of the disclosure.

FIG. 6 is a block diagram of a user equipment according to an embodiment of the disclosure.

FIG. 7 is a block diagram of a network equipment according to an embodiment of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The exemplary embodiments of the disclosure is further described following in conjunction with the accompanying drawings. Text and illustrations are provided as examples only to help readers understand the disclosure. They are not intended and should not be construed as limiting the scope of the disclosure in any way. Although some implementation examples and examples have been provided, based on the content disclosed in this article, it is obvious to the person skilled in the art that the implementation examples and examples shown can be changed without departing from the scope of the disclosure.

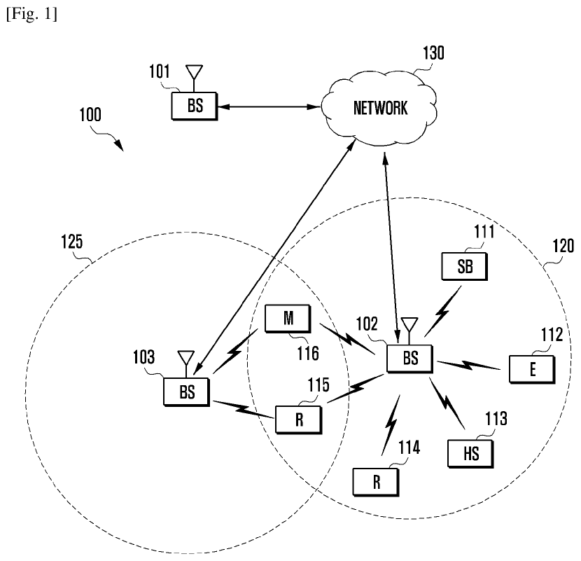

FIG. 1 illustrates an example wireless network 100 according to an embodiment of the disclosure. The embodiment of wireless network 100 shown in FIG. 1 is for illustration purposes only. Other implementations of wireless network 100 may be used without departing from the scope of the disclosure.

Wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as Internet, proprietary IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms may be used, such as “mobile station”, “user station”, “remote terminal”, “wireless terminal” or “user device” can be instead of “user equipment” or “UE”. For convenience, the terms “user equipment” and “UE” are used in this patent document to refer to remote wireless equipment with wireless access to a gNB, no matter whether UE is a mobile equipment (e.g., a mobile phone or smart phone) or a commonly considered fixed equipment (e.g., a desktop computer or vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile equipment (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, the ranges are shown to be approximately circles merely for illustration and explanation purposes. It should be clearly understood that the coverage areas associated with gNBs, such as coverage areas 120 and 125, may have other shapes, including irregular shapes, depending on the configuration of the gNBs and changes in the radio environment associated with natural and man-made obstacles.

As described in more detail below, one or more of gNB 101, gNB 102, and gNB 103 include a 2D antenna array as described in the embodiments of the disclosure. In some embodiments, one or more of gNB 101, gNB 102 and gNB 103 support codebook designs and structures for systems with 2D antenna arrays.

Although FIG. 1 illustrates an example of the wireless network 100, various changes may be made to FIG. 1. For example, a wireless network 100 may include any number of gNBs and any number of UEs in any suitable arrangement. Furthermore, gNB 101 may directly communicate with any number of UEs and provide wireless broadband access to network 130 for those UEs. Similarly, each gNB 102-103 may directly communicate with network 130 and provide UE with direct wireless broadband access to network 130 for the UEs. In addition, gNB 101, 102 and/or 103 may provide access to other or additional external networks, such as external telephone networks or other types of data networks.

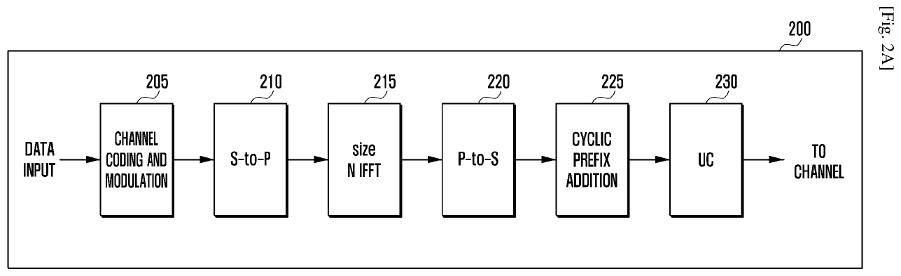

FIGS. 2a and 2b illustrate example wireless transmission and reception paths according to embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support beambook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a group of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency domain signals. The Parallel-to-Serial block 275 converts the parallel frequency domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

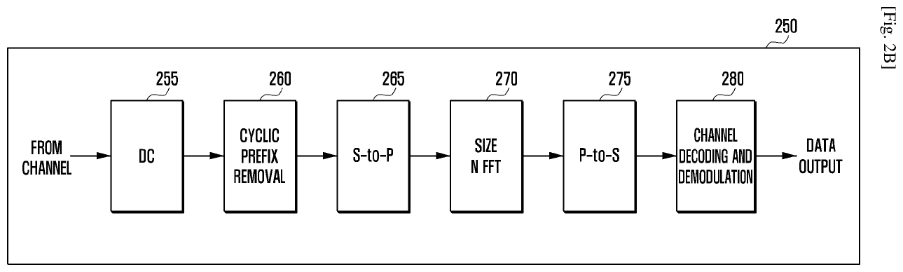

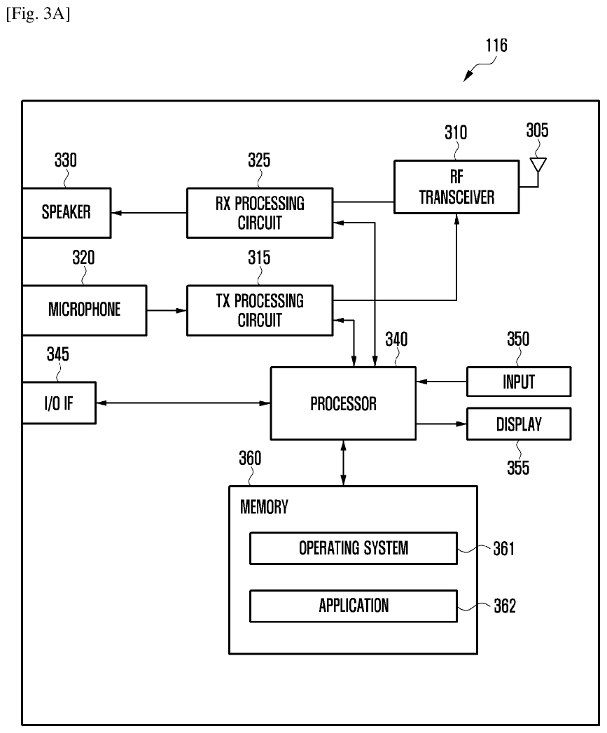

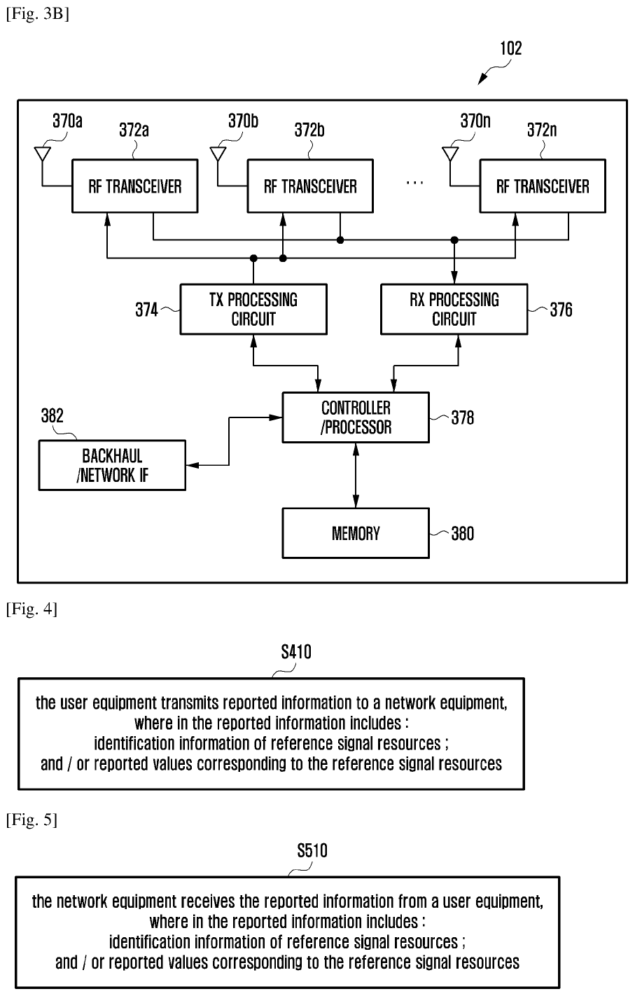

FIG. 3a illustrates an example UE 116 according to an embodiment of the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input equipment(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing equipments and perform an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to perform the application 362 based on the OS 361 or in response to signals received from the gNB or the operator. The processor/controller 340 is also coupled to an I/O interface 345, where the I/O interface 345 provides UE 116 with the ability to connect to other equipments such as laptop computers and handheld computers. I/O interface 345 is a communication path between these accessories and the processor/controller 340.

The processor/controller 340 is also coupled to the input equipment(s) 350 and the display 355. An operator of UE 116 can input data into UE 116 using the input equipment(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed equipments.

FIG. 3b illustrates an example gNB 102 according to an embodiment of the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing equipments that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other equipments or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of indications, such as the BIS algorithm, are stored in the memory. The plurality of indications are configured to cause the controller/processor 378 to perform the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the disclosure are further described below in conjunction with the accompanying drawings. The text and drawings are provided as examples only to help readers understand the disclosure. They should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

In order to enhance the performance of a wireless communication system in high carrier frequency scenes (e.g., FR2), a NR wireless communication system introduces a beam management mechanism for analog beamforming. In general, the beam management mechanism is based on measurement and report of the reference signals by the user equipment. The user equipment may measure a plurality of reference signals (each reference signal corresponds to a beam) so as to determine the beam used by the user equipment to receive the reference signal. For example, based on the measured RSRP (Reference Signal Receiving Power) or L1-SINR (L1-Signal to Interference plus Noise Ratio), up to four optimal measurements (for example, the four reference signals with the largest RSRP) can be reported to the base station. When the base station receives a report from the user equipment, it can select the beam corresponding to one of the reference signals (for example, the largest RSRP) for downlink transmission (DL transmission) based on the measurement results. That is, the user equipment can receive the corresponding downlink transmission (DL transmission) from the base station based on the receiving beam corresponding to the previously determined reference signal. This approach is not optimal to the overhead and delay of beam management. The reason is that if the base station has not transmitted a reference signal in one beam direction, the user equipment has no way to determine the corresponding receiving beam in that beam direction because there is no reference signal information. Therefore, in this new beam direction, the base station must transmit the reference signals for a plurality of times in advance to ensure that the user equipment can receive in the corresponding direction. This leads to a higher delay of beam indication. In order to reduce this delay, an implementation method may, for example, not transmit and measure a reference signal in a new beam direction, but rather infer the characteristics of the new beam direction through a plurality of measured reference signals, thereby transmitting a signal in that direction.

In order to achieve the above methods, information and/or an accuracy provided by existing beam measurement reporting mechanism is insufficient. The disclosure provides a new wireless communication method. In this wireless communication method, the user equipment can report more information to the network equipment, or quantization approach corresponding to the reported value is more flexible, or the reference signal resources have a spatial relationship, etc., which can help the network equipment to more accurately infer characteristics of a new beam direction, thereby helping to reduce the performance degradation of the receiving side (terminal side) and improve the performance of the entire communication system.

A scheme of the disclosure is applicable to (but not limited to) systems using artificial intelligence or machine learning algorithms. Artificial intelligence or machine learning algorithms can be deployed on the base station side to obtain a more accurate (new) beam, or artificial intelligence or machine learning algorithms can be deployed on the terminal side to obtain a more accurate receiving beam (corresponding to the new beam).

FIG. 4 is a flow chart of a wireless communication method performed by a user equipment according to an embodiment of the disclosure.

Referring to FIG. 4, according to various exemplary embodiments of the disclosure, in step S410, the user equipment transmits reported information to a network equipment, the reported information for example, is L1-RSRP (Layer 1 Reference Signal Receiving Power) report, L1-SINR (Layer 1 Signal to Interference plus Noise Ratio) report, or L1-RSRQ (Layer 1 Reference Signal Receiving Quality) report. According to embodiments, the reported information may include identification information of reference signal resources and/or corresponding values of the reference signal resources (also known as “reported values”, which are conveniently referred to as “reported values” for description in the disclosure).

The identification information of the reference signal resources may be reference signal resource identification number (for example, indicator, ID). As an example, the reference signal resource indicator may be either a synchronous signal block resource indicator (SSB resource indicator, SSBRI), or a channel state information reference signal resource indicator (CSI-RS resource indicator, CRI), but not limited to this. Alternatively, SSBRI may include one or more SSBs associated with indexes of PCIs (Physical Cell Identifier (physCellId)). Alternatively, these PCIs are different from the PCIs (physCellId in ServingCellConfigCommon) provided in serving cell common information.

According to embodiments, alternatively, the reported values corresponding to the reference signal resources may be the measurement values obtained by channel measurement according to the reference signal resources, for example, L1-RSRP measurement values. Alternatively, the reported values corresponding to the reference signal resources may be values obtained by quantifying the measurement values (or, measured quantity values) corresponding to the reference signal resources. For example, the measurement values corresponding to the reference signal resources may be the L1-RSRP measurement values, and the reported values may be values obtained by quantifying the L1-RSRP measurement values (also known as L1-RSRP reported values, also known as L1-RSRP values). For example, the reported values corresponding to the reference signal resources may be the L1-RSRP reported values, L1-SINR reported values or, L1-RSRQ reported values, but not limited to this. In the following example, the reported information takes L1-RSRP report as an example, the reference signal resource indicator takes CRI (CSI-RS Resource Indicator) as an example, and the measurement values corresponding to the reference signal resources take the L1-RSRP reported values as an example. It should be noted that although in the following contents, for the convenience of description, the values corresponding to the reference signal resources included in the reported information are called the “reported values”, this is not intended to impose any restrictions on the values, which may further have other names according to the description.

Optionally, the reported information is carried by one of: a physical layer signaling; a media access control layer signaling; a higher level signaling. Herein, the physical layer (layer 1) signaling may be, for example, a physical uplink control channel (PUCCH), a physical uplink shared channel (PUSCH). The media access control (MAC) layer (Layer 2) signaling may be, for example, a MAC control element (MAC-CE). The higher level signaling may be, for example, a wireless resource control RRC signaling.

According to a first exemplary embodiment, a number of reference signals (reference signal resource indicators) included in the reported information is one. Content of the reported information is as follows:
CRI #1→RSRP_17 (reference signal resource indicator→reported value);

In this example, the number of reference signal resource indicators included in the reported information is 1 (for example, nrofReportedRS in CSI-ReportConfig is configured as 1). At this time, the L1-RSRP reported values are 7-bit values with a corresponding range of [−140, −44] dBm and a step size of 1 dB. A mapping relationship between the L1-RSRP reported values and the L1-RSRP measurement values (or a quantization approach, or a quantization approach corresponding to the L1-RSRP reported values) is shown in Table 1.

The range of the L1-RSRP reported values corresponding to the L1-RSRP reported values of CRI #1 is: −140≤RSRP<−139 [dBm].

TABLE 1

| | measurement value | |
|---|---|---|
| | (L1 SS-RSRP and | |
| Reported value | CSI-RSRP) | unit |
| RSRP_0 | Not valid | dBm |
| RSRP_1 | Not valid | dBm |
| RSRP_2 | Not valid | dBm |
| RSRP_3 | Not valid | dBm |
| RSRP_4 | Not valid | dBm |
| RSRP_5 | Not valid | dBm |
| RSRP_6 | Not valid | dBm |
| RSRP_7 | Not valid | dBm |
| RSRP_8 | Not valid | dBm |
| RSRP_9 | Not valid | dBm |
| RSRP_10 | Not valid | dBm |
| RSRP_11 | Not valid | dBm |
| RSRP_12 | Not valid | dBm |
| RSRP_13 | Not valid | dBm |
| RSRP_14 | Not valid | dBm |
| RSRP_15 | Not valid | dBm |
| RSRP_16 | RSRP < −140 | dBm |
| RSRP_17 | −140 ≤ RSRP < −139 | dBm |
| RSRP_18 | −139 ≤ RSRP < −138 | dBm |
| . . . | | . . . |
| RSRP_111 | −46 ≤ RSRP < −45 | dBm |
| RSRP_112 | −45 ≤ RSRP < −44 | dBm |
| RSRP_113 | −44 ≤ RSRP | dBm |
| RSRP_114 | Not valid | dBm |
| RSRP_115 | Not valid | dBm |
| RSRP_116 | Not valid | dBm |
| RSRP_117 | Not valid | dBm |
| RSRP_118 | Not valid | dBm |
| RSRP_119 | Not valid | dBm |
| RSRP_120 | Not valid | dBm |
| RSRP_121 | Not valid | dBm |
| RSRP_122 | Not valid | dBm |
| RSRP_123 | Not valid | dBm |
| RSRP_124 | Not valid | dBm |
| RSRP_125 | Not valid | dBm |
| RSRP_126 | Not valid | dBm |
| RSRP_127 | Infinity | dBm |

According to a second exemplary embodiment, a number of reference signal resource indicators included in the reported information is greater than 1 (for example, nrofReportedRS in CSI-ReportConfig is configured to be greater than 1). A L1-RSRP with the highest measurement value (for example, a L1-RSRP measurement value corresponding to CRI #1) corresponds to a same quantization approach as the previous example (7-bit, quantization with a step size of 1 dB); the quantization approach corresponding to other L1-RSRP reported values is differential quantization (a bits number of the differential quantization is 4). The differential quantization means to quantify RSRP differences between other L1-RSRP measurement values and the highest L1-RSRP measurement value. Specifically, the L1-RSRP is reported as follows (reference signal resource indicator, reported value):
CRI #1→RSRP_111; (corresponding to the highest L1-RSRP measurement value)
CRI #2→DIFFRSRP_0;
CRI #3→DIFFRSRP_2;
CRI #4→DIFFRSRP_5;
according to (the mapping relationship of) Table 1, it can be known that:
a range of the L1-RSRP measurement value corresponding to CRI #1 is:
−140≤RSRP<−139 [dBm];
according to (the mapping relationship of) Table 2, it can be known that:
the difference between the L1-RSRP measurement values of CRI #2 and CRI #1 is:
0≥ΔRSRP>−2 [dB];
the difference between the L1-RSRP measurement values of CRI #3 and CRI #1 is:
−4≥ΔRSRP>−6 [dB];
the difference between the L1-RSRP measurement values of CRI #4 and CRI #1 is:
−10≥ΔRSRP>−12 [dB].

TABLE 2

| | measurement value (Difference | |
|---|---|---|
| | between measured RSRP and | |
| Reported value | strongest RSRP) | unit |
| DIFFRSRP_0 | 0 ≥ Δ RSRP > −2 | dB |
| DIFFRSRP_1 | −2 ≥ Δ RSRP > −4 | dB |
| DIFFRSRP_2 | −4 ≥ Δ RSRP > −6 | dB |
| DIFFRSRP_3 | −6 ≥ Δ RSRP > −8 | dB |
| DIFFRSRP_4 | −8 ≥ Δ RSRP > −10 | dB |
| DIFFRSRP_5 | −10 ≥ Δ RSRP > −12 | dB |
| DIFFRSRP_6 | −12 ≥ Δ RSRP > −14 | dB |
| DIFFRSRP_7 | −14 ≥ Δ RSRP > −16 | dB |
| DIFFRSRP_8 | −16 ≥ Δ RSRP > −18 | dB |
| DIFFRSRP_9 | −18 ≥ Δ RSRP > −20 | dB |
| DIFFRSRP_10 | −20 ≥ Δ RSRP > −22 | dB |
| DIFFRSRP_11 | −22 ≥ Δ RSRP > −24 | dB |
| DIFFRSRP_12 | −24 ≥ Δ RSRP > −26 | dB |
| DIFFRSRP_13 | −26 ≥ Δ RSRP > −28 | dB |
| DIFFRSRP_14 | −28 ≥ Δ RSRP > −30 | dB |
| DIFFRSRP_15 | −30 ≥ Δ RSRP | dB |

Optionally, according to the various exemplary embodiments of the disclosure, the reported information further includes at least one of: spatial information of the reference signal resources, port information of the reference signal resources, grouping information of the reference signal resources, quantization approach information corresponding to the reported values, but not limited to this. As an example, the spatial information includes the spatial relationship information of the reference signal resources.

For example, according to a third exemplary embodiment and a fourth exemplary embodiment, the reported information includes not only the identification information of the reference signal resources and the reported values corresponding to the reference signal resources, but also the port information of the reference signal resources.

According to the third exemplary embodiment, each reference signal resource (e.g., CRI) corresponds to one port or two ports (the reference signals corresponding to the reference signal resources corresponds to one port or two ports). Taking each of all reference signal resources corresponds to two ports as an example. In addition, the reported information includes the reported values of four reference signal resources (a total of eight ports). Wherein each reported value corresponds to a same quantization approach (for example, 7-bit quantization; for example, a same quantization range). Specifically, L1-RSRP is reported as follows (reference signal resource indicator, port number, reported value):
CRI #1, Port #0, RSRP_19;
CRI #1, Port #1, RSRP_18;
CRI #2, Port #0, RSRP_26;
CRI #2, Port #1, RSRP_22;
CRI #3, Port #0, RSRP_20;
CRI #3, Port #1, RSRP_19;
CRI #4, Port #0, RSRP_34;
CRI #4, Port #1, RSRP_38;
According to Table 1 (the mapping relationship), the L1-RSRP measurement values corresponding to each port of each reference signal may be obtained.

According to the fourth exemplary embodiment, for example, each reference signal resource (for example, CRI) corresponds to one port or two ports, respectively. Taking each of all reference signal resources corresponds to two ports as an example in the following. In addition, the L1-RSRP report includes measurement results of four reference signals (a total of eight ports). Wherein for a highest L1-RSRP reported value (CRI #1, Port #1), a first quantization approach is used; for other CSI-RS ports, a second quantization approach is used. The first quantification manner is an absolute quantification (referring to Table 1); the second quantization approach is a differential quantization, which is to quantify the L1-RSRP differences between other L1-RSRP measurement values (CRI corresponding port) and the highest L1-RSRP measurement value. Specifically, the reported information is as follows (reference signal resource indicator, port number, reported value):
CSI-RS #1, Port #0, DIFFRSRP_0;
CSI-RS #1, Port #1, RSRP_18;
CSI-RS #2, Port #0, DIFFRSRP_4;
CSI-RS #2, Port #1, DIFFRSRP_2;
CSI-RS #3, Port #0, DIFFRSRP_1;
CSI-RS #3, Port #1, DIFFRSRP_0;
CSI-RS #4, Port #0, DIFFRSRP_8;
CSI-RS #4, Port #1, DIFFRSRP_10;

The above information may be understood that each port corresponding to the CRIs has a corresponding reported value.

According to Table 1 (the mapping relationship), the L1-RSRP measurement value corresponding to CRI #1, Port #1 may be obtained. According to Table 2 (the mapping relationship), the L1-RSRP measurement values of the ports corresponding to other CRIs may be obtained.

According to the third exemplary embodiment and fourth exemplary embodiment, advantages of the user equipment reporting the L1-RSRP (especially including the corresponding port information) corresponding to the above reference signal resources to the network equipment is that: for a base station with a cross-polarized transmit antenna, each CSI-RS port corresponds to a polarization direction of the base station antenna, and the user equipment may report the L1-RSRP in different polarization directions to the base station, so that the base station can obtain more accurate channel information. This can contribute to improve a system performance (for example, if the base station uses an artificial intelligence/machine learning beam management algorithm to perform related operations based on the reported information, it can contribute to improve the accuracy of the artificial intelligence/machine learning beam management algorithm). For example, the base station may use the L1-RSRP report of the above reference signal resources received from the user equipment to more accurately calculate the transmission parameters of a new reference signal.

Optionally, according to the various exemplary embodiments of the disclosure, the quantification manner corresponding to the reported value is one of the first quantification manner and the second quantification manner. As an example, a quantization step size of the first quantization approach is less than or equal to a quantization step size of the second quantization approach, and/or a range of the first quantization approach is less than or equal to a range of the second quantization approach. Optionally, the range of the first quantization approach is less than the range of the second quantization approach refers to that an upper limit of the first quantization approach (differential quantization) is less than or equal to an upper limit of the second quantization approach (differential quantization).

According to exemplary embodiments, the user equipment determines the quantization approach of the reported values corresponding to the reference signal resources. For example, the wireless communication method shown in FIG. 4 may further include: the user equipment determines a quantization approach corresponding to the reported values according to indication information of the network equipment about the quantization approach corresponding to the reported values; or the user equipment selects the quantization approach corresponding to the reported values among the first quantization approach and the second quantization approach according to a first condition, and transmits indication information about selected quantization approach to the network equipment. That is to say, the user equipment may determine the corresponding quantization approach of the reported values according to the indication of the network equipment, or the user equipment may autonomously select the corresponding quantization approach of the reported values and report the selected quantization approach. As an example, the first condition may relate to, but is not limited to, the measurement values corresponding to the reference signal resources and/or a scene in which the user equipment is located.

As an example, the user equipment may use the following methods to select (determine) the quantization approach corresponding to the reported values:

### The First Method:

The quantization approach corresponding to the reported values is determined according to the indication information of the network equipment (e.g., base station), the indication information may indicate the quantization approach corresponding to the reported values. For example, the indication information may indicate whether the user equipment uses the first quantization approach or the second quantization approach. In addition, the indication information may be an explicit indication or an implicit indication. The explicit indication, for example, is information, transmitted directly by the network equipment to the user equipment, for indicating which quantization approach to use. The implicit indication is other information transmitted by the network equipment to the user equipment (for example, requesting the terminal to report the port information corresponding to the reference signal resources, or other methods, for example, the spatial relationship information), and the other information may be used to implicitly determine which quantization approach the network equipment indicates the user equipment to use. For example, according to the indication of the network equipment for requesting the terminal to report the port information corresponding to the reference signal resources, the quantization approach corresponding to the reported values can be determined.

### The Second Method:

The user equipment autonomously determines the quantization approach corresponding to the reported values. Specifically, the user equipment may determine the quantization approach corresponding to the reported values according to the first condition related to the measurement values corresponding to the reference signal resources. For example, the user equipment may determine whether to use the first quantization approach or the second quantization approach according to the measurement values of the L1-RSRP/L1-SINR/L1-RSRQ of the reference signals (or to obtain the reported values of the corresponding reference signal resources by the first quantization approach or the second quantization approach). For example, if the measurement values of the L1-RSRP corresponding to the reference signal resources of the user equipment exceeds a (effective) range of the first quantization approach, the user equipment quantifies the measurement values of the reference signals according to the second quantization approach for obtaining the corresponding reported values.

In this method, the user equipment may report the selected quantification manner (in the reported information). For example, 1 bit is used to represent the quantization approach. For another example, for reported information carried by a MAC CE, a LCID (logical channel identifier) is used to represent the quantization approach (or the LCID is used to distinguish different quantization approaches). That is to say, the user equipment includes the quantization information of the reported values in the reported information. This quantization approach information indicates the quantization approach of the measurement values by the user equipment.

### The Third Method:

The user equipment autonomously determines the quantization approach corresponding to the reported values. For example, the terminal may determine the quantization approach corresponding to the reported values according to the first condition related to the scene of the user equipment. For example, if the user equipment determines that it is in a “high-speed” scene (the user equipment moves at a high speed) according to measurements (or information obtained by other means) and the scene for the first quantization approach is a “medium speed” or a “low speed”, the user equipment selects the second quantization approach instead of the first quantization approach. For example, if the user equipment determines that it is in the “low speed” scene (the user equipment moves at the low speed) according to the measurement (or information obtained by other means), and the first quantization approach is applicable to the “medium speed” or the “low speed” scene, the user equipment chooses the first quantization approach instead of the second quantization approach. It should be noted that the scene may be related to other information about the user equipment (for example, position information, etc.) in addition to the speed of the user equipment, and there are no restrictions on this herein.

In this method, the user equipment may report the selected quantification manner (in the reported information). For example, 1 bit is used to represent the quantization approach. For example, for the reported information carried by the MAC CE, the LCID is used to represent the quantization approach (or the LCID is used to distinguish different quantization approaches). That is to say, the user equipment may include the quantization information corresponding to the reported values in the reported information. The quantization approach information may indicate the quantization approach of the measurement values corresponding to the reference signal resources by the user equipment.

For example, according to a fifth exemplary embodiment, the number of reference signal resources included in the reported information is 1. In addition, taking the base station indication as an example, the user equipment uses the first quantization approach to quantify the measurement values corresponding to the reference signal resources according to the base station indication. Referring to Table 3, the quantization step size of the first quantization approach is 0.5 dB (less than the quantization step size of the second quantization approach). Referring to Table 3, the quantization step size of the second quantization approach is 1 dB. The reported information, for example, may be as follows:
CRI #→RSRP_17 (reference signal resource indicator→reported value);

In this example, the number of reference signal resource indicators included in the reported information is 1. At this time, referring to the specific mapping relationship in Table 3, it can be known that:

The L1-RSRP measurement value of CRI #1 is: −90.5≤RSRP<−90 [dBm].

TABLE 3

| | measurement values | |
|---|---|---|
| | (L1 SS-RSRP and | |
| Reported value | CSI-RSRP) | unit |
| RSRP_0 | Not valid | dBm |
| RSRP_1 | Not valid | dBm |
| RSRP_2 | Not valid | dBm |
| RSRP_3 | Not valid | dBm |
| RSRP_4 | Not valid | dBm |
| RSRP_5 | Not valid | dBm |
| RSRP_6 | Not valid | dBm |
| RSRP_7 | Not valid | dBm |
| RSRP_8 | Not valid | dBm |
| RSRP_9 | Not valid | dBm |
| RSRP_10 | Not valid | dBm |
| RSRP_11 | Not valid | dBm |
| RSRP_12 | Not valid | dBm |
| RSRP_13 | Not valid | dBm |
| RSRP_14 | Not valid | dBm |
| RSRP_15 | Not valid | dBm |
| RSRP_16 | RSRP < −90 | dBm |
| RSRP_17 | −90.5 ≤ RSRP < −90 | dBm |
| RSRP_18 | −91.5 ≤ RSRP < −91 | dBm |
| . . . | | . . . |
| RSRP_111 | −45 ≤ RSRP < −44.5 | dBm |
| RSRP_112 | −44.5 ≤ RSRP < −44 | dBm |
| RSRP_113 | −44 ≤ RSRP | dBm |
| RSRP_114 | Not valid | dBm |
| RSRP_115 | Not valid | dBm |
| RSRP_116 | Not valid | dBm |
| RSRP_117 | Not valid | dBm |
| RSRP_118 | Not valid | dBm |
| RSRP_119 | Not valid | dBm |
| RSRP_120 | Not valid | dBm |
| RSRP_121 | Not valid | dBm |
| RSRP_122 | Not valid | dBm |
| RSRP_123 | Not valid | dBm |
| RSRP_124 | Not valid | dBm |
| RSRP_125 | Not valid | dBm |
| RSRP_126 | Not valid | dBm |
| RSRP_127 | Infinity | dBm |

According to a sixth exemplary embodiment, the number of reference signals included in the reported information is greater than 1, and a quantization approach corresponding to the highest L1-RSRP measurement value/reported value (corresponding to CRI #1) is same as that of the first exemplary embodiment (7-bit quantization). Optionally, the quantization approach corresponding to the highest L1-RSRP measurement value/reported value is also determined by the user equipment (referring to the fifth exemplary embodiment).

In addition to the above L1-RSRP values, the quantization approach corresponding to other L1-RSRP reported values (corresponding to reference signal resources) is the differential quantization. The definition of the differential quantization is shown in the previous description. Herein the user equipment may determine a quantization approach corresponding to the differential quantization. Herein, taking the method of the base station indicating the quantization approach as an example. That is, the user equipment further receives indication information (which indicates that the differential quantization uses the first quantization approach) from the base station. Wherein, referring to Table 4, a quantization step size of the first quantization approach is 1 dB (less than a step size of the second quantization approach), referring to Table 2, the quantization step size of the second quantization approach is 2 dB. For example, the L1-RSRP is reported as follows (reference signal resource indicator, reported value):
CRI #1→RSRP_111;
CRI #2→DIFFRSRP_0;
CRI #3→DIFFRSRP_2;
CRI #4→DIFFRSRP_5;
according to (the mapping relationship of) Table 1, it can be known that:
the L1-RSRP measurement value of CRI #1 is: −140≤RSRP<−139 [dBm];
according to (the mapping relationship of) Table 4, it can be known that:
the difference between corresponding L1-RSRP measurement values of CRI #2 and CRI #1 is: 0≥ΔRSRP>−1 [dB];
the difference between corresponding L1-RSRP measurement values of CRI #3 and CRI #1 is: −2≥ΔRSRP>−3 [dB];
the difference between corresponding L1-RSRP measurement values of CRI #4 and CRI #1 is: −5≥ΔRSRP>−6 [dB].

TABLE 4

| | measurement value (Difference | |
|---|---|---|
| | between measured RSRP and | |
| reported value | the strongest RSRP) | unit |
| DIFFRSRP_0 | 0 ≥ Δ RSRP > −1 | dB |
| DIFFRSRP_1 | −1 ≥ Δ RSRP > −2 | dB |
| DIFFRSRP_2 | −2 ≥ Δ RSRP > −3 | dB |
| DIFFRSRP_3 | −3 ≥ Δ RSRP > −4 | dB |
| DIFFRSRP_4 | −4 ≥ Δ RSRP > −5 | dB |
| DIFFRSRP_5 | −5 ≥ Δ RSRP > −6 | dB |
| DIFFRSRP_6 | −6 ≥ Δ RSRP > −7 | dB |
| DIFFRSRP_7 | −7 ≥ Δ RSRP > −8 | dB |
| DIFFRSRP_8 | −8 ≥ Δ RSRP > −9 | dB |
| DIFFRSRP_9 | −9 ≥ Δ RSRP > −10 | dB |
| DIFFRSRP_10 | −10 ≥ Δ RSRP > −11 | dB |
| DIFFRSRP_11 | −11 ≥ Δ RSRP > −12 | dB |
| DIFFRSRP_12 | −12 ≥ Δ RSRP > −13 | dB |
| DIFFRSRP_13 | −13 ≥ Δ RSRP > −14 | dB |
| DIFFRSRP_14 | −14 ≥ Δ RSRP > −15 | dB |
| DIFFRSRP_15 | −15 ≥ Δ RSRP | dB |

In addition, in the above method, it can be noted that although the step size in Table 4 is smaller than that in Table 2, the number of the corresponding quantization bits does not increase. This is because the range of the RSRP difference corresponding to Table 4 also becomes smaller (the upper limit of the RSRP difference is reduced from 30 dB to 15 dB). For beam spatial interpolation, it is of little significance to interpolate two reference signals with too large RSRP gap. Therefore, the reduction of RSRP difference range (upper limit) will not reduce the system performance. Therefore, this method avoids the increase of the bits number of reported information under the premise of improving the quantization accuracy, thus improving the system performance.

Optionally, the reference signal resources have spatial relationship according to the various exemplary embodiments. The spatial relationship may include, for example, spatial restriction. The reference signal resources have a spatial relationship, can be understood as there is a spatial relationship between the reference signal resources. For example, the spatial relationship may include at least one of: spatial filters corresponding to the reference signal resources are the same; angles of the spatial filters corresponding to the reference signal resources satisfy a second condition; the reference signal resources cannot be received simultaneously, but is not limited to these. As an example, the second condition may include: angles of the receiving beams (spatial filters) corresponding to any two reference signal resources is less than (or equal to) a threshold; and/or, angles between the receiving beam (spatial filter) corresponding to the largest reference signal resource of the measurement values (e.g., L1-RSRP measurement value) and other reference signal resources are less than (or equal to) a threshold. Alternatively, the second condition may be indicated or predefined by the base station, for example, the threshold may be indicated or predefined by the base station.

For example, the spatial relationship (for example, spatial restriction) may include the following understandings:

### The First Understanding:

The (receiving) spatial filters corresponding to the reference signal resources are the same, or the reference signals associated with these reference signal resources are QCL (quasi-colocated). The terminal equipment enables the base station to obtain finer channel information by providing the above spatial relationship of the reference signal resources, which helps the base station to predict/interpolate downlink beams more accurately.

### The Second Understanding:

The reference signal resources satisfy the angle restriction. For example, the angles between the receiving beams (spatial filters) corresponding to any two reference signal resources are less than (or equal to) a threshold. The threshold can be predefined or determined according to the indication of the base station. In addition, the corresponding configuration range of this threshold can be 0 degree to 60/90 degrees (integer degrees therebetween). Further, the angle of the receiving beams can be determined by the angle of the boresight directions of the two beams (spatial filters); or, the angle of the receiving beams (spatial filters) can be understood as a difference of angles of arrival corresponding to the two reference signals. The terminal equipment enables the base station to obtain finer channel information by providing the above spatial relationship of the reference signal resources, which helps the base station to predict/interpolate downlink beams more accurately.

### The Third Understanding:

The angle restriction is satisfied between the reference signal resources, for example, the angle between the receiving beam (spatial filter) corresponding to the reference signal resource with the maximum measurement value (for example, L1-RSRP) and the receiving beams (spatial filters) corresponding to other reference signal resources are less than (or equal to) a threshold. The threshold can be predefined or determined according to the indication of the base station. In addition, the corresponding configuration range of this threshold can be 0 degree to 60/90 degrees (integer degree therebetween). Further, the angle of the receiving beams can be determined by the angle of the boresight directions of the two beams (spatial filters); or, the angle of the receiving beams can be understood as a difference of angles of arrival corresponding to the two reference signals. The terminal equipment enables the base station to obtain finer channel information by providing the above spatial relationship of the reference signal resources, which helps the base station to predict/interpolate downlink beams more accurately.

### The Fourth Understanding:

The reference signal resources (for example, any two reference signal resources) cannot be received simultaneously. In general, reference signal resources corresponding to the same user equipment panel cannot be received at the same time; reference signal resources corresponding to different user equipment panels can be received simultaneously. Thus, this scheme can be understood as the reference signal resources (indicators) reported by a user equipment are from/about a same receiving panel. The advantage of this restriction is that the network equipment side (base station side) will not use the reference signal resources from different receiving panels for beam interpolation (it is difficult to perform beam interpolation on the reference signal resources received by different panels, and the accuracy is low), thereby reducing the performance degradation of the receiving side. In addition, this fourth understanding may form a combination scheme with the previous three understandings. For example, the reference signal resources reported by the user equipment can meet the angle requirement and cannot be received at the same time.

Optionally, the spatial relationship of the above reference signal resources also is predefined or determined by the user equipment. For example, the wireless communication method shown in FIG. 4 may further include: the user equipment determines whether the reference signal resources have a spatial relationship according to the indication information of the network equipment about the spatial relationship; or, the user equipment determines whether the reference signal resources have a spatial relationship according to the first condition, and transmits indication information to the network equipment about whether the reference signal resources have a spatial relationship.

Specifically, the method for the user equipment to determine whether the reference signal resources have a spatial relationship can be at least one of the followings:

### The First Method:

According to the indication information of the base station. The indication information may indicate whether there is a spatial relationship between the reference signal resources, for example, whether there is a spatial restriction between the reference signal resources. The indication information may be either explicit indication or implicit indication.

### The Second Method:

Autonomously determined by the user equipment. Optionally, the user equipment determines whether the reference signal resources have a spatial relationship according to the first condition. For example, the first condition is related to the measurement values corresponding to the reference signal resources. As an example, the user equipment determines whether there is a spatial restriction between the reference signal resources reported by the user equipment according to the L1-RSRP/L1-SINR (measurement) values of the reference signals. For example, if the measurement values of the L1-RSRP corresponding to the reference signal resources of the user equipment exceed a threshold, there is a spatial relationship between the reference signal resources reported by the user equipment; otherwise, there is no spatial relationship (or no Spatial relationship) between the reference signal resources reported by the user equipment.

In this method, the user equipment (in the reference signal measurement information) reports whether the reference signal resources have a spatial relationship. For example, 1 bit indicates whether there is a spatial relationship. For example, for the reported information carried by the MAC CE, the LCID is used to indicate whether there is a spatial relationship (or, the LCID is used to distinguish whether the spatial relationship is applied). That is to say, the user equipment may include the spatial relationship information in the reported information. The spatial relationship information can indicate whether the reference signal resources have a spatial relationship.

### The Third Method:

Autonomously determined by the user equipment. Specifically, the user equipment may determine whether the reference signal resources have a spatial relationship according to the first condition. For example, the first condition can be related to the scene of the user equipment. For example, if the user equipment determines that it is in a “high-speed” scene (the user equipment moves at the high speed) according to the measurement (or information obtained by other means), and the applicable scene with spatial relationship is the “medium speed” or the “low speed”, then, due to the different corresponding scenes, there is no spatial relationship between the reference signal resources reported by the user equipment.

In this method, the user equipment reports (in the reference signal measurement information) whether the reported reference signal resources have a spatial relationship. For example, 1 bit is used to indicate whether there is a spatial relationship. For example, for the reported information carried by the MAC CE, the LCID is used to indicate whether there is a spatial relationship (or, the LCID is used to distinguish whether the spatial relationship is applied). That is to say, the user equipment may include the spatial relationship information in the reported information. The spatial relationship information may indicate whether the reference signal resources have a spatial relationship.

For example, according to a seventh exemplary embodiment, the number of reference signal resources (indicators) included in the reported information is greater than 1, and the quantization approach corresponding to the highest L1-RSRP measurement value/reported value (corresponding to CRI #1) is predefined (the same as the second exemplary embodiment). In addition, in addition to the highest L1-RSRP measurement value/reported value, the corresponding quantization approach of L1-RSRP reported values is also predefined (the same as the second exemplary embodiment).

For example, L1-RSRP can be reported as follows (reference signal resource indicator, reported value):
CRI #1→RSRP_111;
CRI #2→DIFFRSRP_0;
CRI #3→DIFFRSRP_2;
CRI #4→DIFFRSRP_5;

Different from the second exemplary embodiment, in the present exemplary embodiment, according to the indication of the base station, the CSI-RS resources corresponding to CRI #1, CRI #2, CRI #3 and CRI #4 have a spatial relationship. Specifically, taking the above third understanding as an example, the maximum angle threshold between the CSI-RS resources corresponding to CRI #1 with the largest L1-RSRP measurement value and other reference signal resources (CSI-RS resource corresponding to CRI #2, CSI-RS resources corresponding to CRI #3, CSI-RS resources corresponding to CRI #4) is 60 degrees. The maximum angle threshold is indicated by the base station configuration information. That is to say, the angle between the boresight directions of the receiving beams of the CSI-RS resources corresponding to CRI #1 and CRI #2 is less than (or equal to) 60 degrees; in other words, angles of arrival between the CSI-RS resources corresponding to CRI #1 and CRI #2 is less than (or equal to) 60 degrees. Similarly, CRI #1 and CRI #3, CRI #1 and CRI #4 satisfy this condition. Optionally, on this basis, the user equipment may further determine that the reported CRIs #1, CRI #2, CRT #3, and CRT #4 need to meet following conditions according to the indication of the base station: their corresponding CSI-RS resources cannot be simultaneously received by the user equipment. It can also be understood that the CSI-RS resources corresponding to CRI #1, CRI #2, CRI #3, and CRI #4 are received (and measured) using the same panel.

According to the various exemplary embodiments of the disclosure, the reported information may further include grouping information of the reference signals. As an example, the reference signal resources (or resource indicators) may correspond to a plurality of groups, where the reference signal resources within a same group have a spatial relationship (for example, the spatial relationships described above) and/or quantization of the measurement values corresponding to the reference signal resources is performed for each group respectively. For example, the differential quantization of the measurement values corresponding to the reference signal resources can be performed for each group respectively.

The specific method can be described as a eighth exemplary embodiment described below.

The eighth exemplary embodiment can be an extension of the seventh exemplary embodiment.

According to the eighth exemplary embodiment, the number of reference signal resource indicators included in the reported information may be greater than 1, and a quantization approach corresponding to the highest L1-RSRP measurement value/reported value (corresponding to CRI #1) is predefined (the same as the second exemplary embodiment). In addition, in addition to the highest L1-RSRP measurement value/reported value, the corresponding quantization approach of L1-RSRP reported values is also predefined (the same as the second exemplary embodiment). In addition, the reference signal resource indicators in the reported information are divided into two groups. The first group includes CRI #1 and CRI #2; the second group includes CRI #3 and CRI #4.

Specifically, for example, L1-RSRP can be reported as follows (reference signal resource indicator, reported value, Group ID):

### Group #1

CRI #1→RSRP_111;
CRI #2→DIFFRSRP_0;

### Group #2

CRI #3→DIFFRSRP_2;
CRI #4→DIFFRSRP_5;

According to indication of the base station, the reference signal resources in a same group have a spatial relationship. Specifically, taking the above third understanding as an example, the maximum angle threshold between the CSI-RS resource with the largest L1-RSRP measurement value in Group #1 (corresponding to CRI #1) and other reference signal resources (corresponding to CRI #2) is 60 degrees. This threshold is indicated by the base station configuration information. That is to say, the angle between boresight directions of the receiving beams of the CSI-RS resources corresponding to CRI #1 and CRI #2 is less than (or equal to) 60 degrees; or, angles of arrival of the CSI-RS resources corresponding to CRI #1 and CRI #2 is less than (or equal to) 60 degrees. Optionally, the CSI-RS resources corresponding to CRI #1 and CRI #2 in Group #1 further meet following conditions: they cannot be simultaneously received by the terminal equipment (it can also be understood that the CSI-RS resources corresponding to CRI #1 and CRI #2 are received and measured using the same panel). Similarly, CRI #3 and CRI #4 in Group #2 also meet the restrictions described above.

Optionally, above example may have following variations. For example, the differential quantization may be performed on each group respectively, that is, the user equipment performs the differential quantization on the measurement values corresponding to the reference signal resources for each group respectively.

For example, the reported information can be as follows (Reference Signal Resource ID, Reported Value, Group ID):

### Group #1

CRI #1→RSRP_111;
CRI #2→DIFFRSRP_0;

### Group #2

CRI #3→RSRP_109
CRI #4→DIFFRSRP_3;

That is to say, the CSI-RS resources corresponding to CRI #1 in Group #1 and the CSI-RS resources corresponding to CRI #3 in Group #2 use the absolute quantification manner (similar to the quantification manner of the first exemplary embodiment). The differential quantization may be performed on the other reference signal resources in each group with reference to the highest L1-RSRP measurement value in each group respectively. That is, the difference between the L1-RSRP measurement values of the CSI-RS resources corresponding to CRI #1 and CRI #2 is “DIFFRSRP_0”; the difference between the L1-RSRP measurement values of the CSI-RS resources corresponding to CRT #3 and CRT #4 is “DIFFRSRP_3”. The spatial relationship of the reference signal resources in each group is same as the above example, which is not repeated here.

Above, the wireless communication method performed by the user equipment according to the embodiments of the disclosure is described by referring to FIG. 4 and combining with some of the exemplary embodiments of the disclosure. According to this wireless communication method, it can contribute to reduce the receiving performance degradation of the receiving side (terminal side) and improve the performance of the entire communication system.

FIG. 5 is a flow chart of a wireless communication method performed by a network equipment according to an embodiment of the disclosure.

Referring to FIG. 5, in step S510, the network equipment receives reported information from a user equipment. The reported information includes: identification information of reference signal resource; and/or reported values corresponding to the reference signal resources. Optionally, the reported information may further include at least one of: spatial information of the reference signal resources, port information of the reference signal resources, grouping information of the reference signal resources, and quantization approach information corresponding to the reported values. As an example, the spatial information may include the spatial relationship information of the reference signal resources. According to the exemplary embodiment, the reported information may be carried by one of: a physical layer signaling (for example, PUCCH, PUSCH); a media access control layer signaling (for example, MAC-CE); a higher-level signaling (e.g., RRC signaling).

According to the exemplary embodiment, optionally, a quantization approach corresponding to the reported values may be one of a first quantization approach and a second quantization approach. For example, a quantization step size of the first quantization approach is less than or equal to a quantization step size of the second quantization approach, and/or a range of the first quantization approach is less than or equal to a range of the second quantization approach. In addition, according to the exemplary embodiments, if the quantization approach corresponding to the reported values is selected by the user equipment from the first quantization approach and the second quantization approach, the network equipment may further indicate the selected quantization approach to the terminal equipment. Therefore, alternatively, the wireless communication method shown in FIG. 5 may further include: the network equipment transmits indication information about the quantization approach corresponding to the reported values to the user equipment.

Optionally, according to the exemplary embodiment, the above reference signal resources have a spatial relationship. The spatial relationship may be spatial restrictions, but not limited to this. For example, the spatial relationship includes at least one of: spatial filters corresponding to the reference signal resources are the same; angles of the spatial filters corresponding to the reference signal resources satisfy a second condition; the reference signal resources cannot be received simultaneously. Alternatively, if the above reference signal resources have a spatial relationship, the wireless communication method shown in FIG. 5 may further include: the network equipment transmits indication information about the spatial relationship to the user equipment.

Optionally, according to the exemplary embodiment, the reference signal resources may correspond to a plurality of groups, wherein the reference signal resources within a same group have a spatial relationship and/or quantization of the measurement values corresponding to the reference signal resources is performed for each group respectively.

After the network equipment receives the reported information, optionally, the wireless communication method shown in FIG. 5 may further include: the network equipment determines the parameters for transmitting signal according to the received reported information. For example, an artificial intelligence model is used to predict parameters for transmitting signal based on the reported information. Due to the above improvements of the reported information described above, the network equipment can more accurately determine the parameters for transmitting signal according to the reported information, thus can reduce the receiving performance degradation of the receiving side (terminal side) and improve the performance of the entire system.

Since the reported information involved in FIG. 5 has been introduced in the description in reference to FIG. 4, it will not be repeated here. The relevant content can be seen in the above description.

According to the wireless communication method in FIG. 5, the network equipment can obtain more and/or more accurate reported information, which helps the network equipment to perform corresponding operations more accurately according to the received reported information, for example, determining parameters for transmitting signal (new beams), thus may reduce the receiving performance degradation on the receiving side (terminal side) and improve the overall system performance.

The following is a description of a ninth exemplary embodiment.

The terminal equipment receives configuration information of reference signal from the base station; the configuration information includes one or more groups of reference signal resources. Herein, for example, the reference signal is SSB or CSI-RS.

The terminal equipment reports measurement results corresponding to the one or more groups of reference signal resources based on the configuration information. Optionally, the measurement results are the measurement values. Optionally, the measurement results refer to L1-RSRP. Optionally, the measurement results refer to angle information of the reference signals (e.g., angle of arrival, angle of departure). Optionally, the report is reported through PUSCH. Optionally, the report is reported through MAC-CE. Optionally, the measurement results are Channel impulse responses (CIRs).

Optionally, the terminal equipment further reports the reference signal resource information corresponding to the above measurement results.

Optionally, the terminal equipment further reports the cell information corresponding to the reference signal resource information corresponding to the above measurement results (for example, service cell information; for example, physical cell information (physical cell ID).

Optionally, the terminal equipment further reports position information corresponding to the above measurement results (for example, the position information of the terminal equipment).

Optionally, the terminal equipment further reports speed information corresponding to the above measurement results (for example, the moving speed/rotation speed of the terminal equipment).

Optionally, the terminal equipment further reports signal-to-noise ratio (e.g., SINR or SNR) corresponding to the above measurement results.

Optionally, the configuration information further includes an indication for a purpose of the reference signal resources. For example, the purpose is data collection. For example, the purpose is artificial intelligence/machine learning model training. For example, the purpose is artificial intelligence/machine learning model monitoring.

Optionally, the terminal equipment reports the measurement results corresponding to all reference signal resources in the one or more groups of reference signal resources based on the configuration information. Optionally, for all reference signal resources in this group of reference signal resources, the corresponding measurement results are quantified in a same approach. For example, quantization ranges and/or quantization step sizes are same.

Optionally, the terminal equipment reports the measurement results corresponding to a part of the reference signal resources in the one or more groups of reference signal resources based on the configuration information. Optionally, a part of one or more groups of reference signal resources are determined according to the measurement of the reference signal resources and/or a predefined rule (e.g., priority, a specific subset of the one or more groups of reference signal resources, greater than a specific L1-RSRP threshold).
For example, a part of the reference signal resources in the one or more groups of reference signal resources are determined according to the measurement of the reference signal resources. Optionally, a part of the reference signal resources in the one or more groups of reference signal resources refer to K reference signal resources with largest corresponding measurement values (for example, L1-RSRP) in a group of reference signal resources. Optionally, K is a positive integer (e.g., 1, 2, 3, 4, 5, 6, etc.); for another example, K is greater than or equal to 4). Optionally, K is indicated by the base station. Alternatively, K is related to the capabilities of the terminal equipment. Alternatively, K is predefined.
For example, a predefined rule is priority. Optionally, a part of the reference signal resources in the one or more groups of reference signal resources refer to the reference signal resources corresponding to a group with a high priority. Optionally, the priority of the reference signal resource group is indicated by the base station. Optionally, the priority of the reference signal resource group is predefined (for example, related to a group ID). Optionally, a part of the reference signal resources in the one or more groups of reference signal resources refer to the reference signal resources with a high priority. Optionally, the priority of the reference signal resource is indicated by the base station. Optionally, the priority of the reference signal resource is predefined (e.g., related to the reference signal resource ID).
A specific subset of the one or more groups of reference signal resources. Optionally, this specific subset is indicated by the base station. For example, for a group of reference signal resources (for example, reference signal resource #1, reference signal resource #2, reference signal resource #3, reference signal resource #4, reference signal resource #5, reference signal resource #6, reference signal resource #7, reference signal resource #8), the terminal equipment reports specific one or more of them (for example, reports the corresponding measurement results of the reference signal resource #3, reference signal resource #4, reference signal resource #5) according to the indications of the base station. For another example, for a group of reference signal resource groups (for example, reference signal resource #1, reference signal resource #2, reference signal resource #3, reference signal resource #4, reference signal resource #5, reference signal resource #6, reference signal resource #7, reference signal resource #8), the terminal equipment reports a specific part thereof according to indication of the base station (for example, reports the measurement results corresponding to the reference signal resources with even ID, that is, the measurement results corresponding to the reference signal resource #2, reference signal resource #4, reference signal resource #6, reference signal resource #8).
For example, greater than a specific L1-RSRP threshold. Optionally, a part of the reference signal resources in the one or more groups of reference signal resources refer to the reference signal resources whose measurement values are greater than a specific L1-RSRP threshold. Optionally, the L1-RSRP threshold is indicated by the base station. Optionally, the L1-RSRP threshold is predefined. Optionally, the L1-RSRP threshold is related to the capability of the terminal equipment. Optionally, the L1-RSRP is specific to the reference signal resource group. That is, each of one or more reference signal resource groups corresponds to the L1-RSRP threshold.

Optionally, one reference signal resource in the one or more groups of reference signal resources corresponds to one or more measurement results. Optionally, each one of the measurement result corresponds to one time information. For example, the time information means that measurement result is measured in a time domain resource corresponding to the time information. Optionally, a reference signal resource corresponding to one or more measurement results, refers to (last) N measurement results corresponding to the reference signal resources. N may be a positive integer, for example, 1, 2, 3, 4 and so on. Alternatively, the (last) N measurement results are no later than (or earlier than) the (last) N measurement results of the CSI reference resource. Optionally, N is indicated/configured by the base station. Optionally, N is predefined. Optionally, N is related to a capability of the terminal equipment.

Optionally, the reporting of the above measurement results is indicated by the base station. For example, the base station indicates the terminal equipment to report the measurement results corresponding to the group(s) of reference signal resources through the MAC-CE or DCI indication signalling. The terminal equipment reports the measurement results corresponding to the group(s) of reference signal resources after a first time according to the indication signalling. Alternatively, the first time is predefined. Alternatively, the first time is related to the ability of the terminal equipment. Alternatively, the first time is indicated by the base station.

Optionally, the reporting of the above measurement results is determined/triggered by the terminal equipment. For example, the reporting of the above measurement results is determined/triggered by the terminal equipment according to a size of a buffer (or a remaining size of the buffer). For example, when the remaining size of the buffer is less than a threshold, the terminal equipment triggers/initiates the report. Optionally, the buffer refers to a buffer used for data collection. Optionally, the size of the buffer is related to the ability of the terminal equipment (determined according to terminal equipment capability/capability indication of the terminal equipment). Optionally, the size of the buffer is indicated/configured by the base station. Optionally, the terminal equipment flushes the buffer after reporting. Optionally, the remaining size of the buffer is related to the number of measurement results corresponding to the reference signal resources after the last flush of the buffer.

Optionally, the reported size of the above measurement results is related to the buffer. terminal equipment, the buffer refers to a buffer used for data collection. Alternatively, the size of the buffer is related to the capability of the terminal equipment (as determined by the terminal equipment capability/capability indication of the terminal equipment). terminal equipment, the size of the buffer is indicated/configured by the base station. Optionally, the reported size of the above measurement results is determined by the size of the buffer. Optionally, the reported size of the above measurement results is equal to the size of the buffer.

Optionally, the reported information is used by the base station for model monitoring, model refinement, or model update of artificial intelligence/machine learning models.

Advantages of this exemplary embodiment is that the base station, by the indicating the terminal equipment, can let the terminal equipment to report the complete reference signal measurement results so as to facilitate the data collection of the artificial intelligence/machine learning model (or model monitoring of artificial intelligence/machine learning model) in base station side. Thus, the accuracy of the model and the performance of the communication system can be improved.

The following is a description of a tenth exemplary embodiment.

The terminal equipment receives configuration information of reference signals from the base station; the configuration information includes one or more groups of reference signal resources. Herein, the reference signal is for example SSB or CSI-RS. Optionally, the reported configuration information corresponding to the reference signal configuration information indicates no report (or indicates “none”).

Optionally, the reference signal resources are used for L1-RSRP/L1-SINR measurements. Optionally, the reference signal resources are used for measurement of reference signal angle information (for example, angle of arrival, angle of departure). Optionally, the reference signal resources are used for measurement of channel impulse response.

Optionally, the configuration information further includes an indication of the purpose of the reference signal resources. For example, the purpose is data collection. For example, the purpose is artificial intelligence/machine learning model training. For example, the purpose is artificial intelligence/machine learning model monitoring.

Optionally, the terminal equipment does not report measurement results corresponding to one or more groups of reference signal resources based on the configuration information.

Optionally, the reference signals (or measurement of the reference signals) are used for model monitoring, model refinement, or model update of the artificial intelligence/machine learning model for the terminal equipment.

Advantages of this exemplary embodiment is that the base station, by indicating the terminal equipment, can let the terminal equipment to measure the reference signals without reporting, so as to facilitate the data collection of the artificial intelligence/machine learning model (or the model detection monitoring of the artificial intelligence/machine learning model) in terminal side. Thus, the accuracy of the model and the performance of the communication system can be improved.

The following is a description of an eleventh exemplary embodiment.

The terminal equipment receives configuration information related to a first information from the base station.

the terminal equipment transmits the first information to the base station; wherein the first information includes at least one of the following:
preferred reference signal information;
a time domain pattern corresponding to the preferred reference signal information.

Optionally, the preferred reference signal information refers to the preferred reference signal transmitting information. For example, the reference information is reference signal resource information (for example, a reference signal resource ID), the information refers to the terminal equipment preference of the base station to transmit a reference signal corresponding to the reference signal resource ID. For another example, the reference information is the reference signal resource group information (for example, the reference signal resource group ID). The information refers to the terminal equipment preference of the base station to transmit reference signals corresponding to the reference signal resource group ID (for example, all reference signal resources corresponding to the reference signal resource group ID).

Optionally, the reference signal resources corresponding to the above reference signal information are used for L1-RSRP measurement. For example, the reference signal (or reference signal resource) is configured with a repetition parameter. Optionally, the reference signal resources corresponding to the above reference signal information are used for the measurement of reference signal angle information (for example, angle of arrival, angle of departure). Optionally, the reference signal resources corresponding to the above reference signal information are used for measurement of channel impulse response.

Optionally, the time domain pattern corresponding to the reference signal information refers to the period of the reference signal (or reference signal resource) corresponding to the reference signal information. Optionally, the time domain pattern corresponding to the reference signal information refers to the time domain bitmap corresponding to the reference signal information. Optionally, the time domain pattern corresponding to the reference signal information refers to on and/or off time domain pattern (time domain resource) corresponding to the reference signal information. For example, the reference signal is transmitted in the first time domain resource and not transmitted in the second time domain resource. For example, in addition to the description of the period, the reference signal resources correspond to the time domain position of the reference signals according to the period and offset of the time domain. Furthermore, in addition to the on and/or off indication, the reference signal resources transmission is according to the time domain period and offset information within the first time domain resource.

Optionally, the reference signal (or reference signal transmission/measurement) corresponding to the reference signal information is used for model monitoring, model refinement or model update of artificial intelligence/machine learning models for the terminal equipment.

Advantages of this exemplary embodiment is that the base station, by indicating the terminal equipment, can let the terminal equipment to reported information about the reference signal it wishes to use for measurement, so that the base station can transmit the corresponding reference signal according to the preference of the terminal equipment, so as to facilitate the data collection of artificial intelligence/machine learning model (or the model monitoring of the artificial intelligence/machine learning model) in the terminal side. Thus, the accuracy of the model and the performance of the communication system can be improved.

The following is a description of a twelfth exemplary embodiment.

The terminal equipment receives configuration information related to a second information/second signal from the base station.

The terminal equipment transmits the second information/second signal to the base station. Optionally, the second information/second signal is AI/ML model related.

Optionally, the terminal equipment further transmits reference signal information (or reference signal group information) corresponding to the AI/ML model to the base station.

Optionally, the terminal equipment transmits the second information (for example, the information is an indicator) according to the configuration information. Optionally, the configuration information further includes transmitting the time domain resource information corresponding to the second information, according to which the terminal equipment transmits the second information. Optionally, the time domain resource information includes a time domain period and/or an offset. Optionally, the terminal equipment determines the second information according to measurement results of the reference signals and prediction results (of the AI/ML model). Optionally, when the difference between the L1-RSRP corresponding to the measurement results of the reference signals and the predicted L1-RSRP (predicted by the AI/ML model) is greater than or equal to a threshold, the terminal equipment reports one specific value (for example, 0). Optionally, when the difference between the L1-RSRP corresponding to the measurement results of the reference signals and the predicted L1-RSRP (predicted by the AI/ML model) is less than or equal to a threshold, the terminal equipment reports one specific value (for example, 1).

Optionally, the terminal equipment determines whether to transmit the second information/second signal according to the predefined rules related to the measurement results of the reference signals and the prediction results (of the AI/ML model). Optionally, the predefined rule is related to the difference between the measured results of the reference signals and the prediction results (of the AI/ML model). Optionally, the predefined rule is related to a degree of accuracy/precision/alignment between the measured results of the reference signals and the prediction results (of the AI/ML model). Optionally, when the difference between the L1-RSRP corresponding to the measurement result of the reference signal and the predicted L1-RSRP (predicted by the AI/ML model) is greater than or equal to a threshold, the terminal equipment transmits a second message/second signal. Optionally, when the difference between the L1-RSRP corresponding to the measurement result of the reference signal and the predicted L1-RSRP (predicted by the AI/ML model) is less than or equal to a threshold, the terminal equipment transmits the second information/second signal. Optionally, when the difference between the L1-RSRP corresponding to the measurement result of the reference signal and the predicted L1-RSRP (predicted by the AI/ML model) is greater than or equal to a threshold, the terminal equipment does not transmit the second information/second signal. Optionally, when the difference between the L1-RSRP corresponding to the measurement result of the reference signal and the predicted L1-RSRP (predicted by the AI/ML model) is less than or equal to a threshold, the terminal equipment does not transmit the second information/second signal. Optionally, the threshold is indicated by the base station, predefined, or related to the capability of the terminal equipment.

Optionally, the above measurement result of the reference signal refers to the measurement result of the reference signal resource in a first reference signal resource group. Optionally, the above prediction results (of the AI/ML model) are according to the measurement results of a subset of reference signal resources in the first reference signal resource group. Optionally, the prediction results (of the AI/ML model) are according to the measurement results of the reference signal resources in a second reference signal resource group; wherein the first reference signal group and the second reference signal group are related.

Optionally, the difference between the L1-RSRP corresponding to the measurement result of the reference signal and the predicted L1-RSRP (predicted by the AI/ML model) refers to the difference between the measurement values of one or more reference signal resources in the first reference signal resource group and the predicted values corresponding to one or more reference signal resources. Alternatively, the one or more reference signals refer to X reference signals corresponding to highest (measured/predicted) L1-RSRP. Herein, X is a positive integer, for example, 1, 2, 3, 4, 5. Alternatively, X is indicated by the base station, predefined, or related to the capability of the terminal equipment.

Optionally, the difference between the L1-RSRP corresponding to the measurement result of the reference signal and the predicted L1-RSRP (AI/ML model) refers to the difference between the measurement value of one reference signal resource in the first reference signal resource group and the predicted values corresponding to the reference signal resources.

Optionally, the measurement result can be understood as L1-RSRP/L1-SINR (or the measurement of L1-RSRP/L1-SINR). Optionally, the measurement result is the measurement value. Alternatively, the measurement result is L1-RSRP/L1-SINR. Optionally, the measurement result refers to the angle information of the reference signal (e.g., AoA angle of arrival, AoD angle of departure). Optionally, the measurement result is the channel impulse response (CIR).

Optionally, the prediction results can be understood as L1-RSRP/L1-SINR (or the prediction of L1-RSRP/L1-SINR). Alternatively, the prediction result is the predicted value. Optionally, the prediction result is L1-RSRP/L1-SINR. Optionally, the prediction result refers to the reference signal angle information (for example, AoA angle of arrival, AoD angle of departure). Alternatively, the prediction result is the channel impulse response (CIR).

Optionally, the second information is transmitted through MAC-CE. Optionally, the second information is transmitted through PUCCH/PUSCH. Optionally, the second information is transmitted through PRACH (for example, PRACH for a specific configured resource).

Advantages of this exemplary embodiment is that the base station, by indicating the terminal equipment, can let the terminal equipment to report whether its artificial intelligence/machine learning model is reliable, so as to further determine whether to use the artificial intelligence/machine learning model for the prediction of reference signal measurement results (or beam). Thus, the reliability of the communication system can be improved.

The following is a description of a thirteenth exemplary embodiment.

The terminal equipment receives configuration information of a first reference signal group from the base station; and.
the terminal equipment receives downlink control information (DCI);
the terminal equipment transmits a report related to a first reference signal group according to the DCI.

Optionally, the report refers to an aperiodic report. For example, an aperiodic CSI report.

Optionally, the first reference signal group or the reference signal corresponding to the first reference signal group is configured with a repetition parameter. Optionally, the first reference signal group or the reference signal corresponding to the first reference signal group is used for beam management.

Optionally, the DCI is used to trigger the reporting. For example, the DCI includes a CSI request field; the value corresponding to the CSI request field is used to trigger the report.

Optionally, the terminal equipment determines a time domain position of the reference signal corresponding to the first reference information group according to the configuration information of the first reference signal group. Optionally, the terminal equipment determines a plurality of time slots of the reference signal (or a plurality of time slots where the reference signal located) corresponding to the first reference information group according to the configuration information of the first reference signal group. Alternatively, a first time slot of the plurality of time slots is determined according to an aperiodic offset parameter (for example, aperiodicTriggeringOffset) corresponding to the configuration information of the first reference signal group. For example, the terminal equipment determines the first time slot for receiving the reference signal corresponding to the first reference signal group according to the aperiodicTriggeringOffset parameter in the first reference information group. For example, when a PDCCH corresponding to the DCI is in slot n and the aperiodicTriggeringOffset is Y, the first time slot for receiving the reference signal corresponding to the first reference signal group is slot n+Y.

Optionally, a number of the plurality of time slots (or, the number of times for the transmission of the first reference signal group) is indicated by the base station (or determined by an indication of the base station). For example, the indication is included in the configuration information of the first reference signal group. For example, when the terminal equipment receives the configuration information of the first reference signal group from the base station, the configuration information of the first reference signal group includes the number of times the reference signal is transmitted or the number of time slots corresponding to the reference signal. When the number of times or the number of time slots is, for example, 4, the terminal equipment receives the reference signal corresponding to the first reference signal group at corresponding 4 time slots.

Optionally, an interval between the above plurality of time slots is indicated by the base station. For example, if the base station indicates that the interval between the slots is 2 (and the number is 4), the terminal equipment receives the reference signals corresponding to the first reference signal group at slot n+Y, slot n+Y+2, slot n+Y+4, slot n+Y+6, respectively.

Optionally, the interval between the above plurality of time slots is predefined (e.g., 1). For example, if the interval between timeslots is not indicated, the terminal equipment determines that the interval is 1. That is to say, the terminal equipment receives the reference signal corresponding to the first reference signal group at slot n+Y, slot n+Y+1, slot n+Y+2, slot n+Y+3 (respectively).

Optionally, the report related to the first reference signal group means that a content of the report is determined according to the measurement of the reference signal corresponding to the first reference signal group. Optionally, the report related to the first reference signal group refers to that the content of the report is determined by the measurement of the reference signal corresponding to the first reference signal group in the plurality of time slots. Herein, the method to determine the plurality of time slots can be found above.

Optionally, the reference signal corresponding to the first reference signal group means all reference signals in the first reference signal group. For example, the configuration information corresponding to the first reference signal group is configured with CSI-RS #1, CSI-RS #2, CSI-RS #3, CSI-RS #4, then the reference signals corresponding to the first reference signal group refer to CSI-RS #1, CSI-RS #2, CSI-RS #3, CSI-RS #4.

Optionally, the reference signal corresponding to the above first reference signal group refer to a part of the reference signals in the first reference signal group. Optionally, a part of the reference signals in the first reference signal group are determined according to the reference signal ID. For example, it is determined by the odd/even reference signal ID. For example, the configuration information corresponding to the first reference signal group is configured with CSI-RS #1, CSI-RS #2, CSI-RS #3, CSI-RS #4, then the reference signals corresponding to the first reference signal group refer to CSI-RS #1, CSI-RS #3 (which is determined based on the odd reference signal ID). Optionally, a part of the reference signals in the first reference signal group are indicated by the base station.

Optionally, the report associated with the first reference signal group includes at least one of the following:
reference signal information; optionally, the reference signals corresponding to the reference information belong to the first reference signal group;
quantity corresponding to the reference signal information (for example, L1-RSRP, L1-SINR, channel impulse response).

Optionally, the quantity corresponding to the reference signal information refers to a predicted quantity corresponding to the reference signal information (for example, predicted L1-RSRP, predicted L1-SINR, or predicted channel impulse response).

Optionally, the quantity (or the predicted quantity) corresponding to the reference signal information corresponds to the first time domain information.

Optionally, the first time domain information refers to a time point (e.g., time instance). Optionally, the time point is determined based on a last time slot (or, optionally, a last reference signal transmission) of the plurality of time slots mentioned above. Optionally, the time point is determined based on the last time slot (or, optionally, the last reference signal transmission) of the above plurality of time slots. For example, the base station indicates an offset between the last time slot and the time point, then the terminal equipment determines the position of the time point according to the time slot corresponding to the last time slot in the above plurality of time slots and the offset. For another example, the offset between the last time slot and the time point is equal to an interval between the above plurality of time slots. Thus, the terminal equipment determines the position of the time point according to the interval (or a plurality of the interval) between the time slot corresponding to the last time slot in the plurality of time slots and the plurality of time slots. Optionally, the time point is determined according to the time domain position of the corresponding CSI reference resources corresponding to the above report. For example, the base station indicates the offset between the time domain position of the CSI reference resource corresponding to the above report and the time point, then the terminal equipment determines the position of the time point according to the time domain resource corresponding to the CSI reference resource and the offset. Optionally, the time point is determined according to the time domain position corresponding to the above report. For example, the base station indicates the offset between the time domain position of (PUCCH or PUSCH corresponding to) the above report and the time point, then the terminal equipment determines the position of the time point according to the time domain position (e.g., time slot) corresponding to the above report and offset.

Optionally, the first time domain information refers to a time period. Optionally, a length of the time period is indicated or predefined by the base station. Optionally, (a starting time) of the time period is determined based on the last time slot (or, alternatively, the last reference signal transmission) of the above plurality of time slots. Alternatively, (a starting time) of the time period is determined based on the last time slot (or, alternatively, the last reference signal transmission) of the above plurality of time slots. For example, if the base station indicates the offset between the last time slot and the time period, the terminal equipment determines the starting position of the time period according to the time slot corresponding to the last time slot in the plurality of time slots and the offset. For another example, the offset between the last time slot and the time period is equal to the interval between the above plurality of time slots. The terminal equipment determines the (starting) position of the time period according to the time slot corresponding to the last time slot in the plurality of time slots and the interval between the plurality of time slots. Optionally, (the starting time of) the time period is determined according to the time domain position of the CSI reference resource corresponding to the above report. For example, if the base station indicates the offset between the time domain position of the CSI reference resource corresponding to the above report and the time point, the terminal equipment determines the starting position of the time period according to the time domain position corresponding to the CSI reference signal and the offset. Optionally, (the starting time of) the time period is determined according to the time domain position corresponding to the above report. For example, the base station indicates the offset between the time domain position of (PUCCH or PUSCH corresponding to) the report and the time period, then the terminal equipment determines the starting position of the time period according to the time slot of the time domain position corresponding to the report and the offset.

It should be noted that the reference signal in this embodiment can be understood as the reference signal resource.

Advantages of this exemplary embodiment is that the terminal equipment can obtain the time domain position of the reference signal according to the indication information of the base station. Therefore, the terminal equipment may measure the reference signal according to the time domain position of the corresponding reference signal, and predict the possible changes of the reference signal in future according to the measurement results. Thus, the terminal equipment can report the predicted value of the reference signal to the base station, so that the base station can know channel variations in time, thereby improving the reliability of the communication system.

The following is a description of a fourteenth exemplary embodiment.

The terminal equipment receives configuration information of a first reference signal group from the base station; and.

The terminal equipment transmits a report related to the first reference signal group according to the configuration information.

Optionally, the report is an aperiodic report. For example, an aperiodic CSI report.

Optionally, the first reference signal group or the reference signal corresponding to the first reference signal group is configured with a repetition parameter. Optionally, the first reference signal group or the reference signal corresponding to the first reference signal group is used for beam management.

Optionally, the report related to the first reference signal group means that the content of the report is determined according to the measurement of the reference signal corresponding to the first reference signal group.

Optionally, the report associated with the first reference signal group includes at least one of the following:
reference signal information; optionally, the reference signal corresponding to the reference information belongs to the first reference signal group;
quantity corresponding to the reference signal information (for example, L1-RSRP, L1-SINR, channel impulse response).

Optionally, the quantity corresponding to the reference signal information refers to the predicted quantity corresponding to the reference signal information (for example, predicted L1-RSRP, predicted L1-SINR, or predicted channel impulse response).

Optionally, the quantity (or predicted quantity) corresponding to the reference signal information corresponds to the first time domain information.

Optionally, the first time domain information refers to a time point (e.g., time instance). Optionally, the time point is determined based on the last measurement (or the last measurement/measurement timing) of the reference signal corresponding to the first reference signal group. For example, the base station indicates the offset between the last measurement and the time point, then the terminal equipment determines a position of the time point based on the last measurement and offset. For another example, the offset between the last measurement and the time point is equal to the period of the reference signal corresponding to the first reference signal group. Thus, the terminal equipment determines the position of the time point according to the time domain position of the last measurement and the period. Optionally, the time point is determined according to the time domain position of the CSI reference resources corresponding to above report. For example, the base station indicates the offset between the time domain position of the CSI reference resource corresponding to the report and the time point, then the terminal equipment determines the position of the time point according to the time domain position of the CSI reference resource and the offset. Optionally, the time point is determined according to the time domain position corresponding to the above report. For example, the base station indicates the offset between the time domain position of (PUCCH or PUSCH corresponding to) the above report and the time point, then the terminal equipment determines the position of the time point according to the time domain position of the report and offset.

Optionally, the first time domain information refers to a time period (e.g., time period). Optionally, the length of the time period is indicated or predefined by the base station. Optionally, this time period (the starting time) is determined based on the last measurement (or the last measurement/measurement timing) of the reference signal corresponding to the above first reference signal group. For example, the base station indicates the offset between the last measurement and (the starting time of) the time period, then the terminal equipment determines the position of (the starting time of) the time period according to the last measurement and the offset. For example, the offset between the last measurement and (the starting time of) the time period is equal to the period of the reference signal corresponding to the first reference signal group. Thus, the terminal equipment determines the position of (the starting time of) the time period according to the time domain position of the last measurement and the above period. Optionally, (the starting time of) the time period is determined according to the time domain position of the CSI reference resource corresponding to the above report. For example, the base station indicates the offset between the time domain position of the CSI reference resource corresponding to the above report and the time point, then the terminal equipment determines the starting position of the time period according to the time domain position of the CSI reference resource and the offset. Optionally, (the starting time of) the time period is determined according to the time domain position corresponding to the report. For example, the base station indicates the offset between the time domain position of (PUCCH or PUSCH corresponding to) the above report and the time period, then the terminal equipment determines the starting position of the time period according to the time slot corresponding to the time domain position of the report and the offset.

Optionally, the reference signals corresponding to the first reference signal group means all reference signals in the first reference signal group. For example, if the configuration information corresponding to the first reference signal group is configured with CSI-RS #1, CSI-RS #2, CSI-RS #3, CSI-RS #4, the reference signals corresponding to the first reference signal group refers to CSI-RS #1, CSI-RS #2, CSI-RS #3, CSI-RS #4.

Optionally, the reference signals corresponding to the first reference signal group means a part of the reference signals in the first reference signal group. Optionally, the part of the reference signals in the first reference signal group are determined based on the reference signal ID. For example, it is determined according to the odd/even reference signal ID. For example, the configuration information corresponding to the first reference signal group is configured with CSI-RS #1, CSI-RS #2, CSI-RS #3, CSI-RS #4, then the reference signals corresponding to the first reference signal group refers to CSI-RS #1, CSI-RS #3 (which is determined based on the odd reference signal ID). Optionally, the part of the reference signals in the first reference signal group are indicated by the base station.

It should be noted that the reference signals in this embodiment may be understood as the reference signal resources.

Advantages of this exemplary embodiment is that the terminal equipment can measure the reference signals according to the indications of the base station and predict possible changes in the reference signal in the future. Thus, the terminal equipment can report the predicted value of the reference signal to the base station, so that the base station can obtain the changes of the channel in time and improve the reliability of the communication system.

Above, the wireless communication method performed by the user equipment and the network equipment respectively according to an exemplary embodiment of the disclosure has been described. Below, the user equipment and network equipment are briefly described.

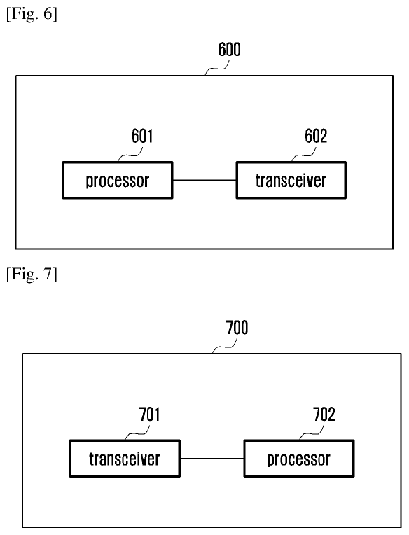

FIG. 6 is a block diagram of a user equipment according to an embodiment of the disclosure.

Referring to FIG. 6, the user equipment 600 may include at least one processor 601 and transceiver 602. Specifically, the at least one processor 601 may be coupled to the transceiver 602 and configured to perform the wireless communication method described above in FIG. 4. The details of the operations involved in the above wireless communication methods can be seen in the description of FIG. 4.

FIG. 7 is a block diagram of a network equipment according to an embodiment of the disclosure.

Referring to FIG. 7, the network equipment 700 may include a transceiver 701 and at least one processor 702. Specifically, the at least one processor 702 may be coupled to the transceiver 701 and configured to perform the wireless communication methods described above in FIG. 5. The details of the operations involved in the above wireless communication methods can be seen in the description of FIG. 5.

At least one of the above modules may be implemented through an AI model. The functions associated with AI may be performed by a non-volatile memory, a volatile memory, and a processor.

The processor may include one or more processors. At this time, one or more processors may be general-purpose processors, such as central processing units (CPU), application processors (AP), etc., processors that are only used for graphics (such as graphics processing units (GPU), vision processors (VPU) and/or AI dedicated processors (e.g., neural processing units (NPU)).

One or more processors control the processing of input data according to a predefined operating rule or an artificial intelligence (AI) model stored in the nonvolatile memory and volatile memory. The predefined operating rule or the artificial intelligence (AI) model may be provided through training or learning. Here, providing through learning means that by applying a learning algorithm to a plurality of learning data, to form a predefined operation rule or AI model with desired characteristics. The learning may be performed in the equipment itself that performs AI according to the embodiment, and/or may be implemented by a separate server/equipment/system.

The learning algorithm is a method that uses a plurality of learning data to train a predetermined target equipment (e.g., a robot) to enable, allow, or control the target equipment to make a determination or prediction. Examples of the learning algorithm include, but are not limited to, supervised learning, unsupervised learning, semi-supervised learning or reinforced learning.

The artificial intelligence model may be obtained through training. Here, “obtained through training” refers to training a basic artificial intelligence model with a plurality of training data through a training algorithm, thereby obtaining a predefined operation rule or an artificial intelligence model, which is configured to perform the required feature (or purpose).

As an example, the artificial intelligence model may include a plurality of neural network layers. Each of the plurality of neural network layers includes a plurality of weight values, and the neural network calculation is performed through the calculation result of the previous layer and the calculation between the plurality of weight values. Examples of the neural network include, but are not limited to, a Convolutional Neural Network (CNN), a Deep Neural Network (DNN), a Recurrent Neural Network (RNN), a Restricted Boltzmann Machine (RBM), a Deep Belief Network (DBN), a Bidirectional Recursive Deep Neural Network (BRDNN), a Generative Adversarial Network (GAN) and Deep Q Network.

According to an embodiment of the disclosure, there may also be provided a computer-readable storage medium storing indications, wherein the indications, when performed by at least one processor, cause the at least one processor to perform the wireless communication method according to the exemplary embodiment of the disclosure. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as multimedia card, secure digital (SD) card or extremely fast digital (XD) card), magnetic tape, floppy disk, magneto-optical data storage device, optical data storage device, hard disk, solid state disk and any other devices which are configured to store computer programs and any associated data, data files, and data structures in a non-transitory manner, and provide the computer programs and any associated data, data files, and data structures to the processor or the computer, so that the processor or the computer may perform the computer programs. The computer programs in the above computer-readable storage mediums may run in an environment deployed in computer equipment such as a client, a host, an agent device, a server, etc. In addition, in one example, the computer programs and any associated data, data files and data structures are distributed on networked computer systems, so that computer programs and any associated data, data files, and data structures are stored, accessed, and performed in a distributed manner through one or more processors or computers.

Those skilled in the art will easily think of other embodiments of the disclosure after considering the specification and practicing the disclosure disclosed herein. The present application is intended to cover any variations, uses, or adaptive changes of the disclosure. These variations, uses, or adaptive changes follow the general principles of the disclosure and include common knowledge or conventional technical means in the technical field that are not disclosed in the disclosure. The specification and the embodiments are only to be regarded as exemplary, and the true scope and spirit of the disclosure are defined by the following claims.

1. A method performed by a user equipment in a communication system, the method comprising:
obtaining reported information; and
transmitting the reported information to a network equipment, wherein the reported information comprises at least one of:
identification information of reference signal resources; or
reported values corresponding to the reference signal resources.

2. The method of claim 1, wherein the reported information further comprises at least one of:
spatial information of the reference signal resources;
port information of the reference signal resources;
grouping information of the reference signal resources; or
quantization approach information corresponding to the reported values.

3. The method of claim 2, wherein the spatial information comprises spatial relationship information of the reference signal resources.

4. The method of claim 2, wherein the quantization approach corresponding to the reported values is one of a first quantization approach and a second quantization approach.

5. The method of claim 4, wherein at least one of below is satisfied:
a quantization step size of the first quantization approach being less than or equal to a quantization step size of the second quantization approach; or
a range of the first quantization approach being less than or equal to a range of the second quantization approach.

6. The method of claim 4, further comprising:
determining the quantization approach corresponding to the reported values according to indication information of the network equipment about the quantization approach corresponding to the reported values; or
selecting the quantization approach corresponding to the reported values among the first quantization approach and the second quantization approach according to a first condition, and transmitting indication information about the selected quantization approach to the network equipment.

7. The method of claim 1, wherein the reference signal resources have a spatial relationship.

8. The method of claim 7, wherein the spatial relationship comprises at least one of:
spatial filters corresponding to the reference signal resources are the same; or
angles of the spatial filters corresponding to the reference signal resources satisfy a second condition; and
wherein the reference signal resources cannot be received simultaneously.

9. The method of claim 7, further comprising:
determining whether the reference signal resources have the spatial relationship according to indication information about the spatial relationship of the network equipment; or
determining whether the reference signal resources have the spatial relationship according to a first condition, and transmitting indication information about whether the reference signal resources have the spatial relationship to the network equipment.

10. The method of claim 6, wherein the first condition is related to measurement values corresponding to at least one of: the reference signal resources or a scene where the user equipment is located.

11. The method of claim 1, wherein the reference signal resources correspond to a plurality of groups, and
wherein the reference signal resources within a same group have at least one of a spatial relationship or quantization of measurement values corresponding to the reference signal resources is performed for each group respectively.

12. The method of claim 1, wherein the reported information is carried by one of:
a physical layer signaling;
a media access control layer signaling; or
a higher level signaling.

13. A method performed by a network equipment in a communication system, the method comprising:
receiving reported information from a user equipment; and
processing the reported information,
wherein the reported information comprises at least one of:
identification information of reference signal resources; or
reported values corresponding to the reference signal resources.

14. A user equipment, comprising:
a transceiver;
a processor coupled with the transceiver and configured to:
obtain reported information; and
transmit the reported information to a network equipment, wherein the reported information comprises at least one of:
identification information of reference signal resources; or
reported values corresponding to the reference signal resources.

15. A network equipment, comprising:
a transceiver;
a processor coupled with the transceiver and configured to:
receive reported information from a user equipment; and
process the reported information,
wherein the reported information comprises at least one of:
identification information of reference signal resources; or
reported values corresponding to the reference signal resources.
